(19) United States
(12) Patent Application Publication
(10) Pub. No.: US 2005/0273757 A1
(43) Pub. Date: Dec. 8, 2005

(54) Methods, systems, and computer program products for summarizing operational behavior of a computer program

(76) Inventor: Craig D. Anderson, Hudson, WI (US)

Correspondence Address: JENKINS, WILSON & TAYLOR, P. A., 3100 TOWER BLVD, SUITE 1400, DURHAM, NC, 27707, US

(21) Appl. No.: 10/862,629

(22) Filed: Jun. 7, 2004

(51) Int. Cl. G06F 9/44

(52) U.S. Cl. 717/100

(57) ABSTRACT

Methods, systems, and computer program products for summarizing operational behavior of a computer program are disclosed. A method for summarizing the operational behavior of a computer program may include executing a computer program in a mode that allows control over execution of the computer program. Execution of the program is paused at predetermined locations corresponding to each instruction in the computer program. For each location, contents of a call stack containing function calls made by the program that have not yet returned are recorded. For each function call in the call stack, information regarding conditions under which the function was called are recorded. Execution of the program is resumed until the next pause location is encountered.

### TECHNICAL FIELD

The present invention relates to the analysis of a computer program to illustrate the inner workings of the program. More particularly, the present invention relates to methods, systems, and computer program products for summarizing operational behavior of a computer program to produce output that is concise and easily understood.

### BACKGROUND ART

Computer programs are often comprised of thousands of lines of code and hundreds of subroutines. As the program is developed it becomes increasingly more difficult to comprehend. As a result, software engineers use diagrams that help to explain the components that comprise a program and how those components interact.

In object-oriented software design, there are two basic logical views of a system, a static view and a dynamic view. A static view answers the question: “What?”. For example, “what are the classes that are used by the program?” In contrast, a dynamic view answers “How?”. For example, “how does the system work?” An object-oriented example of a static view of a system in object-oriented design is called a class diagram. A class diagram illustrates the relationships between a set of classes. An object-oriented example of a dynamic view is a sequence diagram. A sequence diagram illustrates how different objects (instances of classes) interact under a given scenario.

Software engineers use specialized design tools to aid in the documentation of the design of the systems they develop. There are many mature software design tools on the market. These tools vary in sophistication. Some tools are mere drawing tools that allow a user to graphically illustrate the design of a system using standard symbols that are part of the design methodology specification. Other design tools are more sophisticated because they allow the model and the source code to stay synchronized, a process known as round-trip engineering.

The current trend in software design tools is toward automating the often tedious work of drawing design diagrams and to achieve close synchronization with the software source code as changes are made to the system. The market is saturated with software design tools that focus on generating the static view of a system, while not providing any assistance in generating the dynamic view. This is largely because it is quite simple to reverse engineer the static design of a system by analyzing the source code. Generating a dynamic view of the system is much more difficult because it requires analyzing a running program. Some products analyze the source code in an attempt to describe the program flow of a system. The main problem with this approach is that it is impossible to predict the exact behavior of a system without actually running the program. This is because the path of execution depends largely on conditions that are not known until a program is executed.

Tools that are used to analyze the behavior of a system are referred to as profilers. The main purpose of a profiler is to analyze a running program in order to isolate bottlenecks and to improve overall performance. Some diagramming tools utilize profilers in order to build sequence diagrams or call trees. These tools provide some insight into the behavior of a system, but they usually produce output that would consume reams of paper if printed. Typical output includes a listing of the results of execution of each statement, similar to output produced manually by inserting I/O statements to print variable values after each program statement. The reason for such voluminous output is that profilers lack the ability to summarize the execution flow in such a way that can be easily understood by a human.

Some profilers produce sequence diagrams. A problem with current profiling tools that produce sequence diagrams is that the generated documentation lacks critical detail about the execution flow. Two very important aspects of execution flow are execution looping and conditional execution. Current profiling products do not depict looping or conditional execution. However, most programs are composed mainly of execution loops and conditional execution statements. As a result, it is not possible to truly understand why a program is behaving a certain way using current profiling tool technology. A solution is required that can summarize program execution into a sequence diagram that illustrates the nature of the program flow. This can be accomplished by tracking looping and conditional execution and annotating the resulting sequence diagram. However, such tracking and annotating have only been performed manually by software engineers through analysis of thousands of lines of source code and program output.

In light of the problems with current program analysis tools, there exists a long-felt need for improved methods, systems, and computer program products for summarizing operational behavior of a computer program.

### DISCLOSURE OF THE INVENTION

The present invention includes methods, systems, and computer program products for summarizing the execution flow of a computer program. According to one method, a computer program is executed in a mode that allows control over execution of the program. Execution of the program is paused at locations corresponding to instructions in the computer program. For each location, contents of a call stack containing function calls made by the program that have not been returned are recorded. For each function in the call stack, conditions under which the function was called are recorded. The conditions may include the sequence of functions that resulted in the current function being called and whether the function is executing in a loop. In implementation, the contents of the call stack may be recorded on a data structure, referred to herein as a shadow stack. A new shadow stack instance may be created for each breakpoint location. A summarized call tree may be used to store relationships between calls for each instance of the shadow stack. Computer program output may be presented to the user in a summarized format, such as a sequence diagram. Post processing of intermediate or machine code corresponding to the computer program may be performed to add notation to the sequence diagram that indicates guard conditions for loops and conditionally executed blocks of code.

Although the methods and systems described herein may produce a sequence diagram for display to the user, the present invention is not limited to producing sequence diagrams. Alternative diagrams that may be produced by the methods and systems described herein to illustrate operational behavior of a computer program include behavioral views of the system, such as collaboration diagrams, state diagrams, and object interaction diagrams.

One aspect of the invention may include analyzing the execution flow of a computer program by monitoring function/method calls made by a program. The analysis may include detecting when the program is in an execution loop or when a program has conditionally executed a block of code. This information is used to summarize the behavior of a program by expressing function call sequences with loop and conditional execution notation. One problem that is solved by the present invention is how to identify where the execution loop actually exists. One exemplary implementation described herein determines the origin of an execution loop by combining the use of the shadow stack, a local loop counter, and the summarized call tree.

In one exemplary implementation, the present invention includes a sequence analysis engine (SAE). The SAE utilizes debugger services in order to examine and record the execution flow of a computer program. By using debugger services, it is meant that the SAE uses services provided by a debugger application programming interface (API), such as the WINDOWS® debugger API. While most debuggers are used by computer programmers to isolate and fix bugs in computer programs, one exemplary implementation of the present invention includes an approach that automates the use of debugger services to control, examine, and record the execution of a computer program. The SAE utilizes common debugger services to inspect the state of an executing program, to set and clear debug breakpoints, to single step into/over computer instructions, to control the execution of threads and processes, and to access debug symbols associated with the target program.

An alternative approach to using debugger services involves using profiler services to track method entry and exit events. The disadvantage of this approach is that every function call incurs overhead because profilers track all method calls in an application. Using debugger services is more efficient because debug breakpoints are used to focus analysis only on those classes/methods that are of interest to the user.

In an implementation that utilizes profiler services, the SAE may use profiler call back functions for each method call in a program. Profilers typically require special instructions to be placed at the beginning of each method. These instructions are designed to interrupt the execution of the target program and allow a monitoring service to take control. In one exemplary implementation of the present invention, the SAE may be called by the profiler for each method call in a program being monitored. The SAE may then record the function call and inspect the target application memory, call stack, and registers to determine whether the function call is being conditionally executed or whether the function call is part of an execution loop.

Although using profiler services is one possible method for analyzing the operational behavior of a computer program, using profiler services is less efficient than using debugger services because using profiler services does not enable a user to selectively enable and disable monitoring of user-specified functions. A profiler requires that each function be analyzed. Requiring that each function be analyzed increases unnecessary processing in analyzing a computer program.

Another advantage to using debugger services over profiler services is that debugger services allow the sequence analysis engine to dynamically explore new interactions between functions using the single step debugger service combined with breakpoint service. The ability to dynamically explore new interactions between functions is referred to herein as auto-discovery mode. Auto-discovery mode is not possible using profiler services because profiler services do not allow single stepping services or breakpoint services.

A GUI application that allows a user to configure inputs for the SAE, control the operation of the SAE (start, stop, pause), and to view and manipulate the outputs from the SAE may be provided. The SAE interacts with the debugger to control the target application and examine/record its execution using input provided via the GUI. In an alternate implementation, the GUI may be omitted. In such an implementation, the SAE may be executed by the user from a command prompt. With this approach, the user may be responsible for manually editing the SAE input file. The SAE may produce the analysis results to a text file that could be viewed by the user.

The methods and systems for analyzing operational behavior of a computer program described herein may be used in a variety of software development and testing scenarios. One such scenario is referred to as extreme programming. Rapid application development methodologies, such as extreme programming, advocate developing computer programs by skipping formal analysis and design and jumping immediately into programming. This approach encourages programmers to constantly refactor their programs until the desired solution is obtained. Unfortunately, this approach will leave very little design artifacts for other software developers who later must maintain or add features to the program. A software tool, as described herein, automatically generates concise, easy-to-understand, sequence diagrams that explain how certain aspects of the program function. This tool fits perfectly into the extreme programming paradigm because it allows the software engineers to focus on developing the program while automatically producing up-to-date documentation for communicating the design of the system.

Another application of the methods and systems described herein is behavioral model verification. Large software firms, especially those producing software for government agencies, are required to follow formal design methodologies. During the detailed design phase of software development, these firms produce design documentation for both the static and dynamic aspects of the system. After the design has been reviewed and approved, the actual software development begins. Often times, the software development is performed by an entirely different group of people. As a result, there is often a disconnection between the designer's intent and the actual implementation. The formal software development process requires model verification after the software implementation is complete. At this stage, source code reviews are held and a determination is made as to whether the program has been implemented according to the design. Reviewing source code can be useful in verifying the static design of a system; however, it does not address the dynamic aspects of the design. A tool, as described herein, may be used to perform model verification of the behavioral aspects of the design.

Yet another application of the methods and systems described herein is automatic generation of computer program behavioral documentation for use in maintaining legacy software. The software life-cycle of a computer program typically includes the following: requirements, analysis, design, implementation, testing, installation, operation, maintenance, and retirement. Quite often, software engineers involved in the early design of a system are not the same individuals that are responsible for maintaining the system. In fact, in many software projects, by the time a product reaches the maintenance phase of the software life-cycle, the original designers of the software are no longer available, having either changed projects or in some cases, jobs. This presents a problem when a software maintenance engineer is attempting to fix a bug in a system that has out-dated documentation. The maintenance engineer must spend countless hours pouring over source code, debugging the application, or asking others for helpful insight. As described above, tools already exist that generate up-to-date documentation on the static design of a system. Unfortunately, static design documentation alone often cannot provide the maintenance engineer with enough information to isolate and fix program bugs. A tool that can automatically generate documentation that describes the behavior of a system would have a profound impact on reducing the cost of maintenance in this scenario. The maintenance engineer could run the tool under different conditions to generate behavioral diagrams that can be compared and used to isolate the problem. The methods and systems described herein provide such a tool.

The methods and systems described herein may include an approach for generating a dynamic view of a computer program that is concise and easily understood by the user. Such a tool has utility in rapid application development, formal software development, and in reducing the cost of maintaining legacy software systems.

Accordingly, it is an object of the invention to provide methods, systems, and computer program products for summarizing the operational behavior of a computer program.

It is another object of the invention to provide methods, systems, and computer program products for identifying loops and conditional execution in computer programs and displaying the loops and conditional execution to a user in a summarized format.

Some of the objects of the invention having been stated hereinabove, other objects will become evident as the description proceeds when taken in connection with the accompanying drawings as best described hereinbelow.

### BRIEF DESCRIPTION OF THE DRAWINGS

Preferred embodiments of the invention will now be explained with reference to the accompanying drawings of which:

FIG. 1 is a sequence diagram that does not include notation for illustrating conditional program execution or looping;

FIG. 2 is a diagram of a computer program that contains execution loops and conditional statements;

FIG. 3 is a sequence diagram illustrating execution of the program in FIG. 2 without notation for conditional execution or looping;

FIG. 4 is an example of a sequence diagram including loop and conditional execution notation that may be automatically produced by a method for summarizing operational behavior of a computer program according to an embodiment of the present invention;

FIG. 5 is a summarized call tree illustrating relationships between method calls;

FIG. 6 is a summarized call tree illustrating an execution loop by maintaining loop counters for each called method;

FIG. 7 is a diagram illustrating source code and corresponding assembly language code used for detecting conditional execution of a function call using a sequence analysis engine according to an embodiment of the present invention;

FIG. 8 is a flow chart illustrating exemplary steps for post-processing of intermediate code to generate conditional and loop notation for a sequence diagram according to an embodiment of the present invention;

FIG. 9 is a unified modeling language (UML) class diagram illustrating relationships between exemplary classes used to summarize operational behavior of a computer program according to an embodiment of the present invention;

FIG. 10 is a block diagram illustrating exemplary relationships between a shadow stack and a summarized call tree used for summarizing operational behavior of a computer program according to an embodiment of the present invention;

FIG. 11 is a flow chart illustrating exemplary steps that may be performed by a sequence analysis engine in summarizing operational behavior of a computer program according to an embodiment of the present invention;

FIG. 12 is a flow chart that illustrates an exemplary process that may be performed by a sequence analysis engine in updating a shadow stack and a summarized call tree according to an embodiment of the present invention;

FIG. 13 is a flow chart illustrating exemplary steps that may be performed by a sequence analysis engine in detecting execution loops and storing loop counts according to an embodiment of the present invention;

FIG. 14 is a block diagram illustrating an exemplary overall architecture of a system for summarizing operational behavior of a computer program according to an embodiment of the present invention;

FIG. 15 is a block diagram illustrating exemplary debugger services that may be used by a sequence analysis engine according to an embodiment of the present application;

FIG. 16 is a block diagram illustrating data flow and exemplary relationships between components of a system for summarizing operational behavior of a computer program according to an embodiment of the present invention;

FIG. 17 is a flow chart illustrating exemplary steps for initiating analysis of a target application according to an embodiment of the present invention; and

FIG. 18 is a flow chart illustrating exemplary steps performed when a user stops analysis of a target application according to an embodiment of the present invention.

### DETAILED DESCRIPTION OF THE INVENTION

The following terms and definitions are used in explaining details of embodiments of the invention:

API—stands for application programming interface, a standard used by computer programmers to allow operating systems and software applications to understand one another.

breakpoint—a place in a source code program that stops the debugger during program execution. Breakpoints aid in the testing and debugging of programs.

C++—an object-oriented programming language based on the C language.

call or function call—an expression that moves the path of execution from the current function to a specified function and evaluates to the return value provided by the called function.

call stack—the list of procedures and functions currently active in a program.

call tree—a data structure used to record a computer program's function call sequence. Also, a display that documents function usage hierarchy.

class—one of the key concepts in object-oriented programming, a class is the most general kind of user-defined type, defining both the state information used by objects of the class (data members) and their behavior (member functions). Classes may be related to one another via inheritance relationships, where base classes define portions of the interface and/or implementation of derived classes.

class diagram—a diagram that shows a collection of declarative (static) model elements, such as classes, types, and their contents and relationships.

collaberation diagram—a diagram that shows object interactions organized around the objects and their links to each other. Unlike a sequence diagram, a collaboration diagram shows the relationships among the objects. Sequence diagrams and collaboration diagrams express similar information, but show it in different ways.

conditional statement—in a programming language, a statement (for example, the if statement) that evaluates one or more variables or conditions and uses the result to choose one of several possible paths through the subsequent code.

debug symbols—information used by a debugger to link machine instructions to higher level source code and to display variable names and type information.

debugger—a software tool that is used to detect the source of program or script errors by performing step-by-step execution of application code and viewing the content of code variables.

disassemble—to transform machine codes into assembler language.

function—a specialized group of statements used to encapsulate general or program-specific tasks.

guard condition—a condition that must be satisfied in order to proceed executing a block of code.

GUI—an acronym for graphical user interface. This term refers to a software front-end meant to provide an attractive and easy-to-use interface between a computer user and application.

intermediate language—in computer programming, a target language into which all or part of a single statement or a source program in a source language is translated before it is further translated or interpreted.

loop—a set of instructions executed repeatedly as long as some condition is met.

machine language—a binary language (using only 0s and 1s); the only programming language the computer understands. All programs written in higher-level languages must be translated into machine language before they can be executed.

method—an operation defined for an object, implemented as a procedure or function in a programming language.

object—in object-oriented design or programming, a concrete realization of a class that consists of data and the operations associated with that data.

object interation diagram—a diagram that shows the dynamic message-passing relationship between objects, including which object owns the data being passed and which object owns the service being called.

process—a process is a single executable module that runs concurrently with other executable modules.

sequence diagram—a diagram that shows object interactions arranged in time sequence. In particular, it shows the objects participating in the interaction and the sequence of messages exchanged. Unlike a collaboration diagram, a sequence diagram includes time sequences but does not include object relationships.

shadow stack—a data structure that reflects the current contents of the program's call stack.

single step—a debugger command that allows an application program to execute one line of the program, which can either be a single assembly language instruction or a single high level language instruction. There are typically two distinct single step commands—one that will single step “into” subroutine calls and one that will step “over” them.

source code—the readable form of code created by a programmer in a high-level programming language. Source code is converted to machine-language object code by a compiler or interpreter.

state diagram—a model of the states of an object and the events that cause the object to change from one state to another.

thread—the basic unit of program execution. A process can have several threads running concurrently. Each thread can be performing a different job, such as waiting for events or performing a time-consuming task that the program does not need to complete before the program continues. Generally, when a thread has finished performing its task, the thread is suspended or destroyed.

UML—stands for unified modeling language. UML is a standard notation and modeling technique for analyzing real-world objects, developing systems, designing software modules in object-oriented approach. UML has been fostered and now is accepted as a standard by the group for creating standard architecture for object technology, OMG (Object Management Group).

The present invention may include a system that can automatically generate a diagram that illustrates the operational behavior of a software program. In one exemplary implementation, a system for summarizing the operational behavior of a computer program may automatically generate a sequence diagram including notation for illustrating conditional execution and looping. Alternate implementations may include generation of other behavioral views of the system, including collaboration diagrams, state diagrams, and object interaction diagrams.

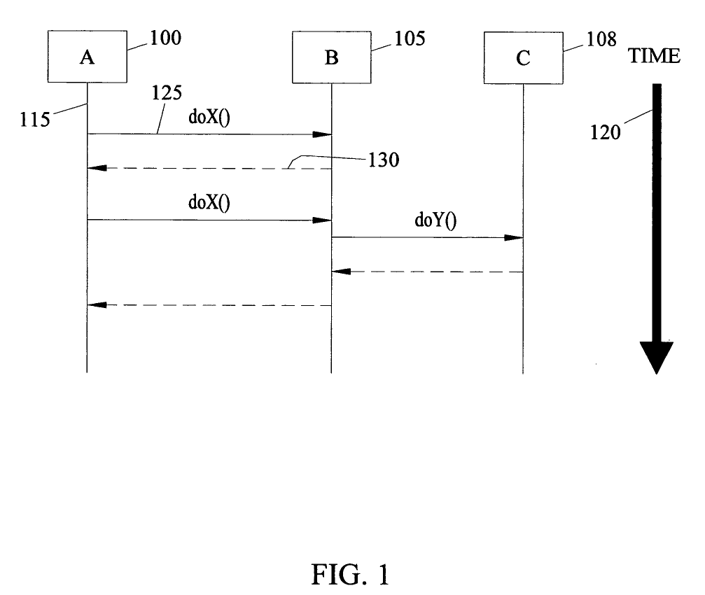

Before explaining details of how conditional execution and looping can be automatically identified, sequence diagrams will first be explained. A sequence diagram describes the interaction between a set of objects for a given scenario. FIG. 1 provides a simple example of a sequence diagram that illustrates the interaction between objects A, B, and C for an unspecified scenario. The objects are indicated in boxes 100, 105, and 108. The vertical line, such as vertical line 115, extending from each object is referred to as the object's lifeline, and it represents the time for which the object exists in the system. Time flows from the top of the diagram towards the bottom of the diagram, as indicated by arrow 120. The horizontal lines, such as line 125, between the object lifelines represent messages sent (or methods called) from one object to another. For example, horizontal line 125 shows that object A 100 has invoked the doX method of object B 105. Horizontal dashed line 130 indicates that control has returned to object A.

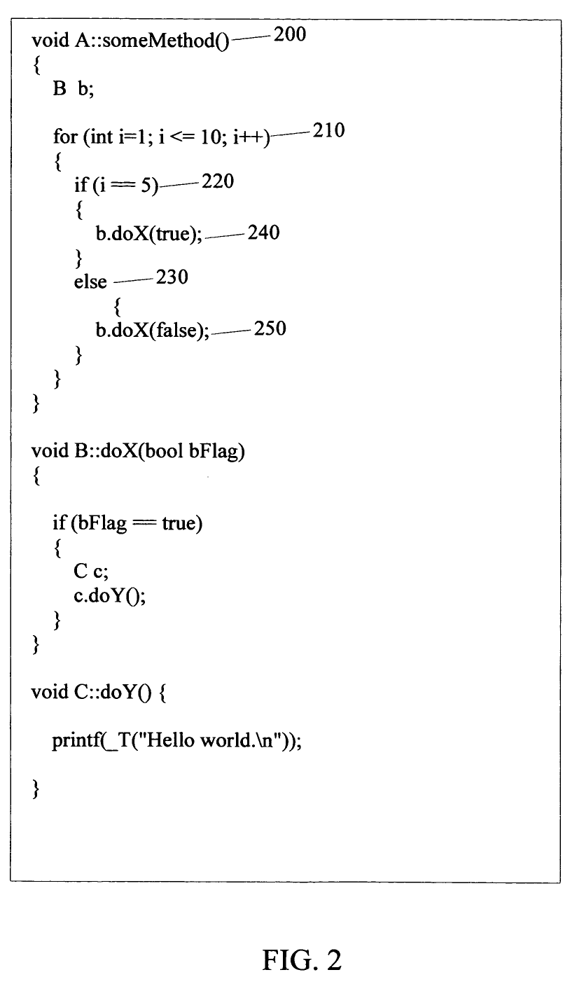

The notation used in FIG. 1 is not sufficient to concisely illustrate more complex behavior which is typical of most programs. For example, in the C++ code illustrated in FIG. 2, the method “someMethod” 200 illustrates a simple “for” loop 210 that contains an “if-else” statement 220 and 230. The “if” portion of the “if-else” statement calls doX method 240 of object b with a value of true, and the “else” portion of the “if-else” statement calls the doX method of object b with a value of false. If the bFlag variable of the doX method is set to true, the doX method creates an object c of class C and calls doY. DoY prints the screen output, “Hello World.” If the bflag variable of the doX method is set to false, no screen output is produced. As illustrated by the “if” statement indicated by reference number 220, the bFlag variable is only set to true on the fifth iteration of the “for” loop indicated by reference numeral 210. Thus, the result of executing the program illustrated in FIG. 2 will be the calling of the doX method with a value of false in iterations 1-4 and 6-10 and the calling of the doY method from the doX method in iteration 5.

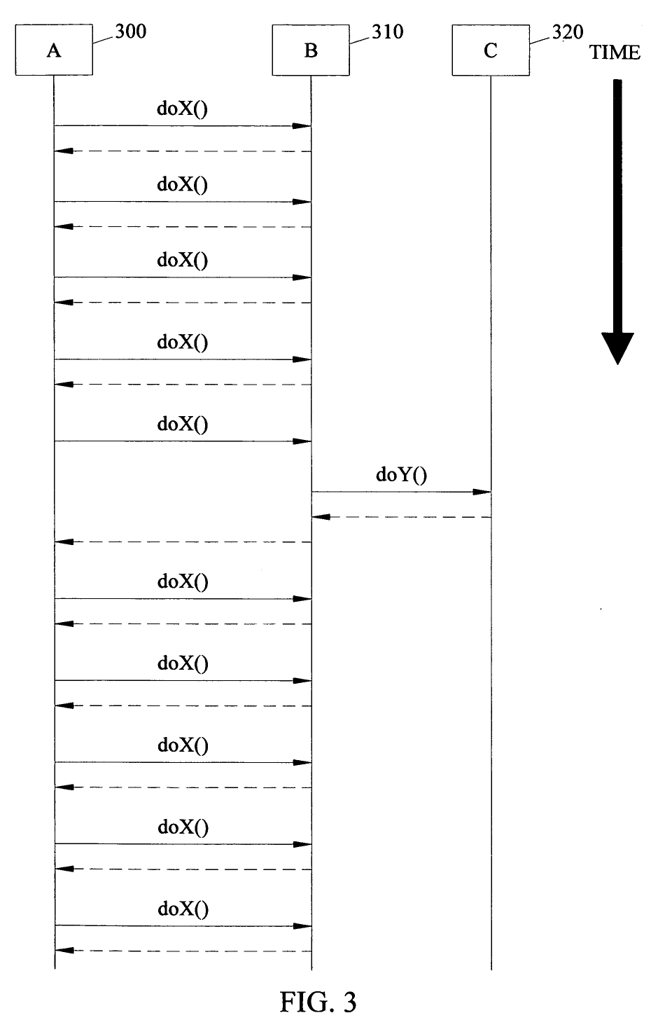

While the operation of someMethod can be understood by examining the source code, it would be difficult to truly understand the program flow using the limited notation from FIG. 1. FIG. 3 attempts to illustrate the behavior of “someMethod” 200 using the limited notation from FIG. 1. The sequence diagram shown in FIG. 3 lacks notation to illustrate the “for” loop and the “if else” statement, yet these elements are required to accurately depict the true behavior of “someMethod” 200. In FIG. 3, the method doX is called ten times by someMethod of object A 300. In the fifth iteration of doX, the doX method of object B 310 calls the doY method of object C 320. However, there is no indication using the notation in FIG. 3 of why doX was called ten times or why doY was called in the fifth iteration of doX. Fortunately, the UML standard for sequence diagrams includes notation that can be used to represent execution loops and conditional execution. However, the UML standard does not specify a mechanism for generating such notation. As a result, the UML notation for loops and conditional execution has typically been generated manually by programmers.

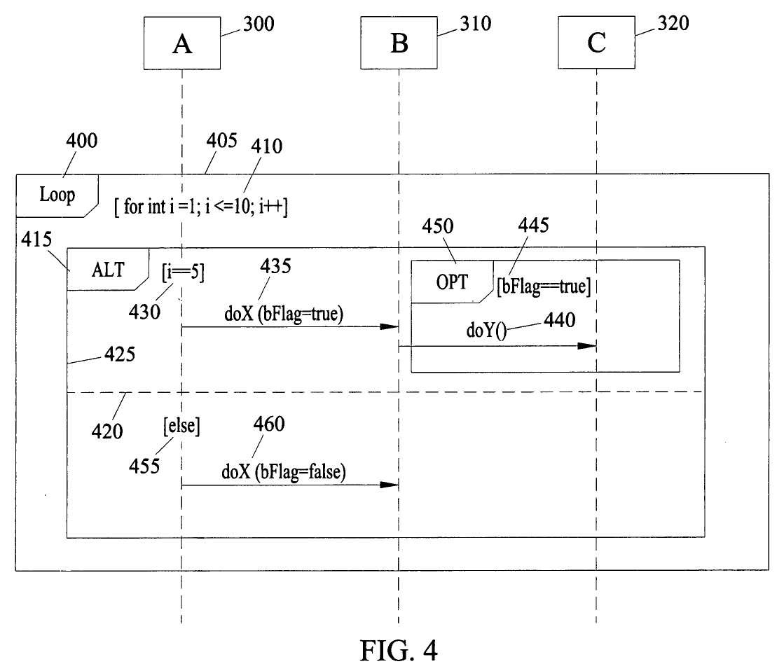

The notation in FIG. 3 can be contrasted with the notation of FIG. 4, which is a UML sequence diagram of “someMethod” 200 that utilizes notation for representing execution loops and conditional statements. The notation for representing execution loops and conditional statements in FIG. 4 can be automatically generated using the methods, systems, and computer program products for analyzing operation behavior of a computer program described herein. Conventionally, such notation was required to be generated by a programmer or software engineer through manual analysis of source code and program output. Such a manual process is labor intensive and subject to human error.

In FIG. 4, “for” loop 210 from FIG. 2 is illustrated using loop operator 400. The scope of the “for” from FIG. 2 is illustrated utilizing UML notation referred to as an interaction frame 405. Reference numeral 410 indicates the guard condition for “for loop” 210. The “if else” statement 220 from FIG. 2 is depicted using interaction frame and the ALT (short for alternative) operator 415. Horizontal dashed line 420 provides a boundary between the “if” clause and the “else” clause of “if else” statement 220. Everything above dashed line 420 and within ALT interaction frame 425 occurs when guard condition 430 evaluates to true. In the illustrated example, if guard condition 430 evaluates to true, object A calls b.doX with a value of true, as indicated by reference numeral 435. b.doX then calls c.doY, as indicated by reference numeral 440, when guard condition 445 is true. OPT interaction frame 450 indicates that doY only executes if guard condition 445 is true. OPT interaction frame 450 is equivalent to ALT interaction frame 425 with only one option.

Everything below dashed line 420 and within ALT interaction frame 425 occurs when guard condition 430 evaluates to false. In the illustrated example, 430 is false, guard condition 455 is true and doX is called with a value of false, as indicated by reference numeral 460.

The sequence diagram in FIG. 4 provides a much more concise, and accurate, depiction of the true behavior of the program than the sequence diagram in FIG. 3. One embodiment of the invention provides a method of summarizing the execution of a computer program in such a way as to enable generation of UML sequence diagrams containing loop and conditional execution notation as shown in FIG. 4. This method provides detailed steps for monitoring the execution flow in order to detect and record situations in which a program is executing a block of statements in a loop or when a program has conditionally executed a block of statements. Although this embodiment generates UML sequence diagrams to illustrate the execution flow of the program, alternative approaches may generate other behavior-oriented diagrams, such as object interaction and collaboration diagrams. In some situations it may be desired to operate the SAE, which will be described in detail below, without generating a diagram. For example, the raw SAE output can be analyzed and compared to output from previous analysis sessions to verify model compliance and to highlight areas where the design has changed.

Most modern computer programs are written in a high level language, referred to as source code language. The syntax of these high level languages provides the ability to make function calls, to conditionally execute a block of code, and to execute the same block of code in a loop until some condition is met. The present invention may include analyzing the execution flow by monitoring function/method calls made by a program. In addition, the present invention may include intelligent monitoring that can detect when the program is in an execution loop or when a program has conditionally executed a block of code. This information may be used to summarize the behavior of a program by expressing the function call sequences with loop and conditional execution notation, as illustrated in FIG. 4.

A function call allows a program to temporarily branch to another location to execute a series of statements and then to return the point of origin and continue execution. Functions are blocks of code (computer statements) that can be called in order to perform a specific task. In object-oriented programming, objects have actions, referred to as methods, which can be invoked by other objects. A method invocation is analogous to calling a function in a non-object-oriented computer language. Most computer programs are composed of hundreds, if not thousands, of objects, each object having many methods. In object-oriented languages, methods are used to express the actions that can be performed by an object. Software engineers who are designing object-oriented programs utilize sequence diagrams to document the interaction between objects and the behavior of a program. In contrast to sequence diagrams, class diagrams are used to document the static design of an object-oriented system. The present invention may include the ability to monitor the interaction between the objects that comprise a computer program. Although one exemplary implementation described herein focuses on analyzing object-oriented programs, the methods and systems described herein for analyzing operational behavior of a computer program can also be used to monitor the interaction of modules and associated functions of a non-object-oriented application, such as a procedure-oriented application.

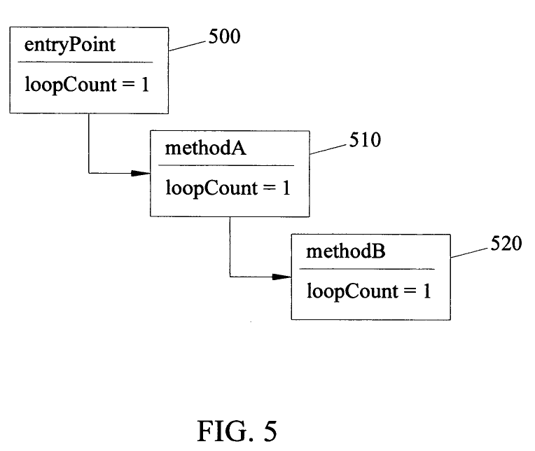

In one implementation of the present invention, interactions between methods or functions in a computer program may be recorded into a data structure referred to herein as a summarized call tree, as illustrated in FIG. 5. A summarized call tree is a hierarchical representation of present and past sequences of method calls made by a program. Each branch of the tree corresponds to method calls that were made during execution of the program. A summarized call tree differs from a standard call tree because it maintains the state of method calls that were made while in an execution loop. The first instance of a method call made while executing in a loop will result in a single child node corresponding to the called method being added to the tree. Subsequent calls to the method from within the execution loop are recorded by incrementing a local loop count associated with the call node. After the execution analysis has ended, the summarized call tree can be used to identify method calls that were made while in an execution loop. The ability to identify calls that were made in an execution loop is critical to produce sequence diagrams that provide loop notation to express the behavior a system.

In FIG. 5, node 500 represents the root node or entry point method of the summarized call tree, which is named entryPoint. Node 510 represents methodA being called from entryPoint and is added to the summarized call tree with a loop counter of 1 the first time that entryPoint calls methodA. Node 520 represents methodB being called from methodA and is added to the summarized call tree with a loop counter of 1 the first time that methodA calls method B. The purpose of the summarized call tree in FIG. 5 is to record enough information to track the context when each method is called so that sequence diagrams, such as the sequence diagram illustrated in FIG. 4, can be automatically generated with notation to illustrate conditional execution and looping.

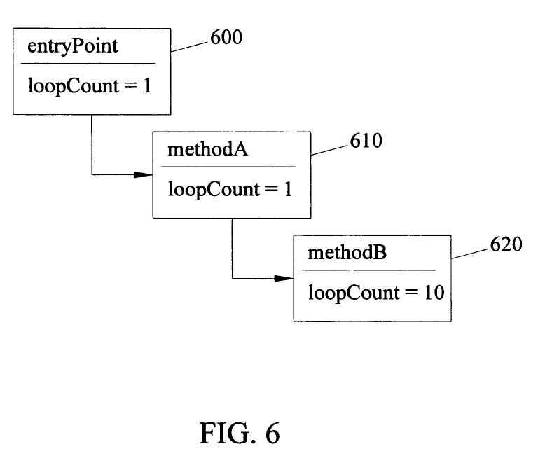

FIG. 6 illustrates another example of a summarized call tree. In FIG. 6, node 600 represents the entry point method, which is named entryPoint. Node 610 represents the first calling of methodA from entryPoint. Node 620 represents methodB being called from methodA. In node 620, the loop count associated with methodB is ten, indicating that methodB was called ten times by methodA. A mechanism for automatically generating a summarized call tree, such as those illustrated in FIGS. 5 and 6, and using this information to summarize operational behavior of a computer program will be described in detail below.

As stated above, one important aspect of the present invention is the ability to automatically identify conditionally executed blocks of code, referred to as conditional statements, and adding conditional execution notation to sequence diagrams. Returning to FIG. 2, the exemplary source code contains conditional statements. The first conditional statement is an “If” statement 220 that also contains an “else” clause 230. This conditional statement can be interpreted as saying “if variable i is equal to 5, then execute b.doX(true) 240 otherwise execute b.doX(false) 250. ” The lowercase “b” in the b.doX( ) method call represents the object “b” which is an instance of class “B.” The characters “doX” in the method call represent the doX method of object B being called. The value within the parenthesis, “true” or “false”, represents the value being passed to the method doX. In the source code example, b.doX is only passed a value of “true” on the fifth time through the enclosing execution loop, see 240. A sequence diagram would depict the conditional execution of this statement by using ALT notation 415 to represent the “if, else” statement. However, using conventional software engineering tools, such as diagrams are required to be manually generated.

The inclusion of conditional execution notation in a sequence diagram helps to explain the conditions under which a method or a block of methods are called. A sequence analysis program, such as a sequence analysis engine according to an embodiment of the present invention, preferably captures the conditional execution flow so that generated sequence diagrams can provide conditional execution notation.

In order to detect conditional execution, the SAE may record method calls between selected classes based on filter criteria established by the user. Recording a method call involves recording both the callee and the caller. The caller contains information about the origin of a call. The callee contains information about the destination of a call. Each call that is monitored may be placed in a summarized call tree which may be later used to create visual representations of the execution flow.

In one exemplary implementation, the SAE performs post analysis of the calls contained in the call summary tree. The main purpose of this post analysis is to identify calls made from blocks of statements contained by a conditional statement. This is accomplished by analyzing the machine/intermediate language code for each caller contained in the call tree and locating low level computer instructions that were generated from high level language conditional statements. These low level instructions are referred to as conditional branching instructions because they allow the processor to jump over blocks of instructions based on some condition. Example conditional branch instructions that the SAE may analyze in detecting conditional execution may include machine instructions, such as jz, jne, jge jump zero, jump not equal, jump greater than or equal). These instructions require a location to jump to if the condition is met.

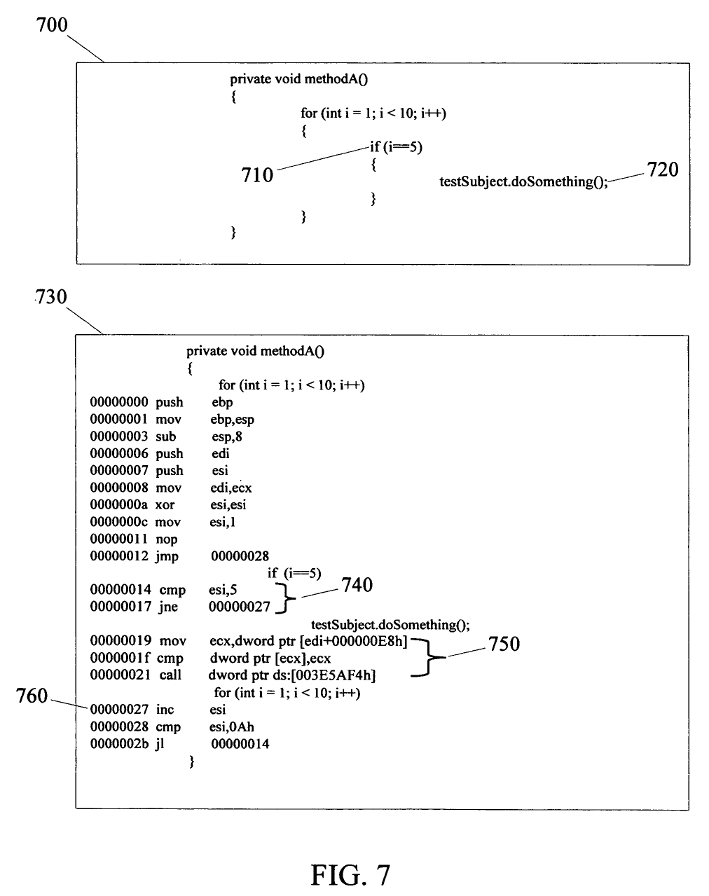

FIG. 7 illustrates an example of how a high level “if” statement may broken down into low level assembly statements suitable for post-analysis of function calls to identify guard conditions and loop counts according to an embodiment of the present invention. In FIG. 7, reference numeral 700 represents the original source code containing an “if” statement 710. In the source code, if i==5, the method testSubject.doSomething is executed, as indicated by reference numeral 720. The block of code represented by reference numeral 730 shows how each high level computer statement is broken down into one or more low level assembly instructions. Assembly instructions 740 correspond to the “if” statement 710. Assembly instructions 750 contain the JNE (Jump Not Equal) assembly instruction. The computer will jump over the instructions 750, which correspond to testSubject.doSomething, if the preceding comparison operation indicates that the value stored in the ESI register is not equal to five. In other words, the assembly code 750 is conditionally executed, the condition being when i=5. The SAE may store the scope of the conditionally executed assembly block 750 by recording the location of the JNE instruction and jump target location 760. In this example, the scope of the conditional block would be the open range (0x17, 0x27). Any statements contained in this range would be identified by the sequence analysis engine as being conditionally executed. All calls in the call tree that have callers in the bounded area are then flagged as belonging to the same conditionally executed block of call statements.

In one exemplary implementation of the sequence analysis engine, debugger symbols can be used to locate the line(s) of source code that correspond to the analyzed branch instructions. This information can then be presented on a sequence diagram as depicted in FIG. 4 using ALT guards, such as 430 and 455 illustrated in FIG. 4. In some situations, debug symbols may not be available. In this case, the GUI application (described in detail below) may allow the user to manually annotate the generated diagrams.

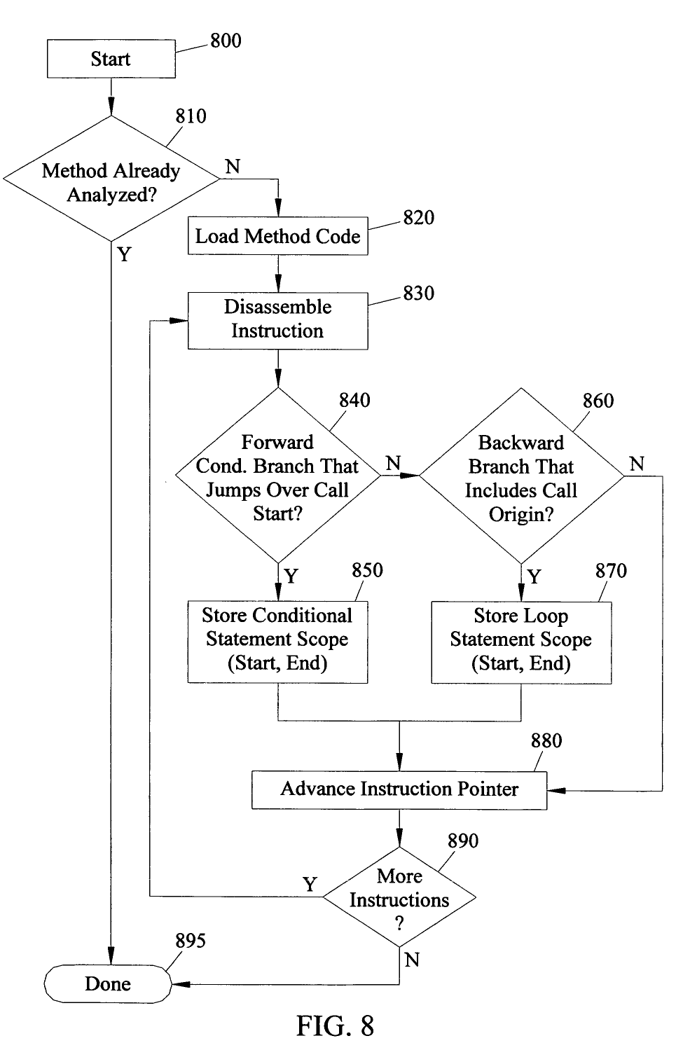

FIG. 8 further illustrates an exemplary process that may be executed by a sequence analysis engine according to an embodiment of the present invention in determining the scope of conditional and loop statements that may contain one or more call statements. The process of determining conditional or loop statement scope begins in step 800. Provided the method has not already been analyzed (step 810), the first step in the process is to load the machine/intermediate code associated with the method being analyzed (step 820). Next, the first instruction is disassembled (step 830). In step 840, it is determined whether the current intermediate instruction being analyzed is a forward conditional branch. If the instruction is a conditional branching instruction that has a target offset greater than the offset of the branch instruction, then the branch is considered a forward conditional branch. In FIG. 7, the jne instruction located at offset 17 has a target offset of 27. Thus, the jne statement would be identified as a forward conditional branch.

Forward conditional branching is indicative of conditionally executed code blocks. If the disassembled instruction is a forward conditional branch, then the starting and ending offset of the conditionally executed block of code is stored for later use (step 850). If the current instruction is not a forward conditional branch, control proceeds to step 860 where it is determined whether the current instruction is a looping instruction. If the current instruction is a branch that specifies a target offset less than the offset of the branch offset, then a loop has been detected. In this case, the starting and ending offset of the loop are stored for later use (step 870).

After checking for the existence of forward conditional branches and backward conditional branches or loops, the SAE advances to the location of code where the next instruction is located (steps 880 and 890). If the method contains additional instructions then the process described above is repeated starting at step 830. If all of the intermediate language instructions have been analyzed, the process of checking for loops and conditional execution ends in step 895.

The conditional and loop statement scopes that are recorded in this phase are later used when rendering diagrams, such as sequence diagrams, that illustrate the execution flow of the program. For example, in the case of a sequence diagram, if a block of call statements are contained by or within the starting and ending offsets of a conditional statement, an interaction frame can be drawn around the method calls. Returning to FIG. 4, interaction frame 425 contains a method call 435. In addition to drawing the interaction frame, the sequence analysis engine may use the scope information stored for the conditional statement along with debug symbols to add the guard notation containing the line of source code that was associated with the low level forward conditional branch. In FIG. 4, reference numeral 430 represents the guard condition (i==5) associated with the jne statement in FIG. 7. Similarly, loop statement scope information may be used to render the loop interaction frame and loop guard condition. In FIG. 4, frame 400 is a loop interaction frame rendered for the loop in the source code illustrated in FIG. 2. Reference numeral 410 illustrates the guard condition (for int i=1; I≦10; i++) for the loop. Such guard conditions are invaluable in illustrating the operational behavior of a program. Because the present invention is capable of automatically identifying execution loops and conditional execution and function calls make within the loops or conditionally executed blocks of code, sequence diagrams containing guard condition notation, such as that illustrated in FIG. 4 can be automatically generated.

Most computer programs contain blocks of statements that are executed repeatedly in an execution loop. The following pseudo-code to read each line from a file and print it to the computer console illustrates the value of execution loops in computer programs:

While Not EndOfFile(someFile) Do

text = ReadLine(someFile)
Console.Print text

End While

Without a looping construct, this program would be difficult, if not impossible, to write. Since the programmer may not know ahead of time how many lines of text are contained in the file, it would be impossible to know how many ReadLine function calls to make in order to read all lines of text contained in the file. The “while” loop provides a concise mechanism for expressing which statements are to be executed in the loop and the condition that must be met in order to continue looping over the statements.

Sequence diagrams provide notation for expressing method calls that are made inside of an execution loop. In FIG. 4 an execution loop is expressed in UML 2.0 notation. Loop operator 400 specifies that all function calls made within the interaction frame 405 are to be repeated in an execution loop while the guard condition 410 is met.

The present invention may include a method for summarizing the execution flow of a computer program by identifying method calls that were made in the context of an execution loop. This enables the generation of sequence diagrams such as in FIG. 4 that concisely describe the behavior of a computer program using loop notation.

As described above, a summarized call tree contains nodes that represent unique execution paths made by a computer program. If the same path is encountered more than once, a loop counter is incremented at the point in the tree where the path was repeated. For example, if the call sequence:
entryPoint→methodA→method B
occurs, a sequence analysis engine may store this information in a summarized call tree as illustrated in FIG. 5. The summarized call tree stores the method call information in a tree data structure. Each node of the tree represents a method call. The directional arrow represents the relationship between the parent call to a child call. A parent call represents a method that executed the child call. The summarized call tree differs from a normal call tree because in a summarized call tree a loop count is incremented each to time the call occurs; whereas, in a normal call tree a call object is stored for each call. Each call in FIG. 5 has a loopCount equal to 1. This indicates that the calls have only been called once and therefore have not been called in a loop.

As described above, FIG. 6 illustrates the summarized call tree if methodB was called by methodA 10 times while in an execution loop. In this case, the loopCount associated with methodB has the value 10. Since entryPoint and methodA each have loopCount set to 1 we know that methodB was called 10 times by methodA. In addition, we know that it was executed in a loop, as opposed to individual sequential calls, since the call information stored in the summarized call tree represents an exact location within the method that executed the call.

One problem that must be overcome is to identify where the execution loop actually exists. It is not enough to know that the sequence entryPoint→methodA→methodB was encountered 10 times because entryPoint could be calling methodA in a loop, methodA could be calling methodB in a loop, or both entryPoint and methodA could contain execution loops. The present invention includes a mechanism to overcome this problem. In one exemplary implementation, the present invention may utilize a data structure, referred to herein as a shadow stack, may be to record the number of times a method call was made by the callee while the callee or calling function was on the call stack, i.e., before the calling function returns. The shadow stack may contain a snapshot of the executing program's call stack at a specific time. The SAE maintains the shadow stack by actively monitoring method calls and method returns. When a new method call is monitored, the information about the call is pushed onto the top of the shadow stack. When the call returns to the callee, the corresponding entry is popped from the shadow stack. The call information is stored in an object referred to herein as a call object. The call object may be stored or encapsulated in another object, referred to herein as a StackFrame object. The StackFrame object may be stored on the shadow stack.

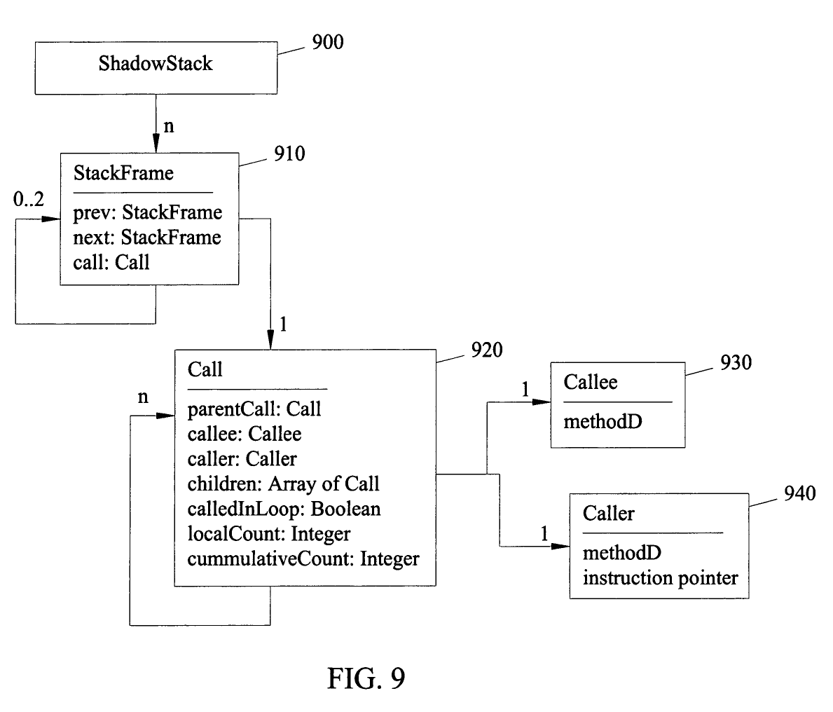

FIG. 9 is a UML class diagram that illustrates the class relationship between a shadow stack 900, a StackFrame 910, and a call 930. Shadow stack 900 is a stack data structure that contains zero or more StackFrame objects 910. Each StackFrame object 910 has a reference to a call object 920. A call object 920 can contain zero or more call object children. In addition, each call object 920 contains references to a caller object 930 and a callee object 940. A caller object represents a method that originated the call. In addition, caller object 940 contains the instruction pointer of the next machine/intermediate language statement to execute upon return of the call. Callee object 930 represents the method that is being called by the callee. The callee refers to the object that contains the called method.

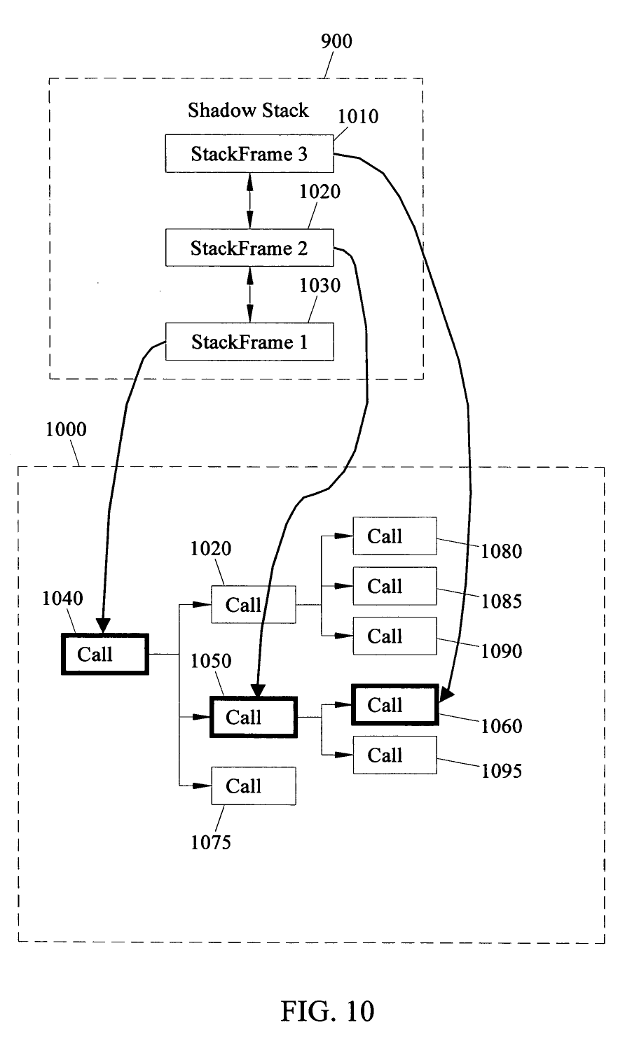

In one exemplary implementation, the SAE places a reference to the call object into the summarized call tree, described above, when the call object is created and placed in a frame of the shadow stack. The summarized call tree maintains a history of each method call made by the program. The shadow stack maintains a history of each call that is currently represented on the program's call stack. FIG. 10 illustrates the relationship between shadow stack 900 and a summarized call tree 1000. Shadow stack 900 contains a collection of StackFrame objects 1010, 1020, and 1030. Each StackFrame object 1010, 1020, and 1030 represents the context of a method that is in the process of being executed. Each StackFrame object 1010,1020, and 1030 has a reference to a call object. Summarized call tree 1000 also contains references to call objects that are currently on shadow stack 900, as indicated by reference numerals 1040, 1050, and 1060. Summarized call tree 1000 also contains references to call objects that were previously on shadow stock 900, as indicated by reference numerals 1075-1095.

As new calls occur, corresponding call objects are encapsulated by a StackFrame object which is in turn pushed onto shadow stack 900. When a call returns to the originating method, the corresponding StackFrame object is popped from shadow stack 900 and then discarded. The main distinction between the roles of summarized call tree 1000 and shadow stack 900 is that summarized call tree 1000 maintains a historic collection of all calls that have been monitored by the system, whereas the shadow stack 900 references only those calls that are “active” on the monitored program's call stack.

In FIG. 10, stack frame object 1030 represents the first function call made by the program that has not yet returned made. This information is recorded in summarized call tree 1000 by call object 1040. When another function is called from the function corresponding to the stack frame object 1030, stack frame object 1020 is added to shadow stack 900. Similarly, call object 1050 is added to summarized call tree 1000. When the next function is called from the function that corresponds to stack frame object 1020, stack frame object 1010 is added to shadow stack 900. Similarly, call object 1060 is added to summarized call tree 1070. When the function that corresponds to stack frame object 1010 returns, it is removed from shadow stack 900. However, call object 1060 will remain in summarized call tree 1000. Thus, summarized call tree 1000 stores a history of past instances of shadow stack 900.

After the function corresponding to stack frame object 1010 returns, the next function called within the function that corresponds to stack frame object 1020 will be added to the branch of summarized call tree 1000 after call object 1050. For example, the next call may be indicated by call object 1095. Thus, by maintaining a shadow stack that contains objects corresponding to functions that have not returned and a summarized call tree that represents a history of functions that have been called and context between the function calls, the present invention allows automatic generation of summarized computer program information.

Using a shadow stack allows the SAE to determine where the execution loop is located. As described above, it is not enough to simply count the number of occurrences of a particular call. In order to accurately depict the flow of execution, the SAE preferably determines where the loop (or loops) occurred that resulted in multiple occurrences of the call. Maintaining a shadow stack allows the SAE to keep track of the local loop count for each call that is active on the monitored program's call stack.

As described above, the present invention may utilize debugger services to set breakpoints in the monitored program. Breakpoints are special instructions that, when executed, cause a debug exception to occur. Debuggers intercept these exceptions and use them to gain control of the currently executing program. Having suspended execution of the program, the debugger can inspect the content of the program, including the call stack, threads, local variables, computer registers, and the contents of addressable memory. The SAE uses debugger breakpoints to gain control of a program at predetermined locations, referred to herein as sequence points. A sequence point is established by setting a function breakpoint on the first instruction of a method. The SAE utilizes sequence points to focus analysis on interactions between select classes and/or methods. Although one exemplary implementation of the invention utilizes debug breakpoints to gain control of a program, alternative approaches could also be used. For example, the SAE may overwrite instructions in the target application with special instructions (such as a kernel mode function call) that would result in the SAE gaining control of the application. The overwritten instructions would be restored once the SAE has finished processing the exception.

When a sequence point breakpoint occurs, the SAE updates the shadow stack and the summarized call tree with information from the monitored program's call stack. After the shadow stack has been updated, the SAE utilizes the local loop count attribute of the stack frame to detect the origin of execution loops that involve methods that are active on the monitored program's call stack. The final step taken by the SAE when processing a sequence point breakpoint is to scan the current method for call instructions, if it has not already been scanned, and to set breakpoints on the scanned call instructions. These breakpoints are referred to herein as call points.

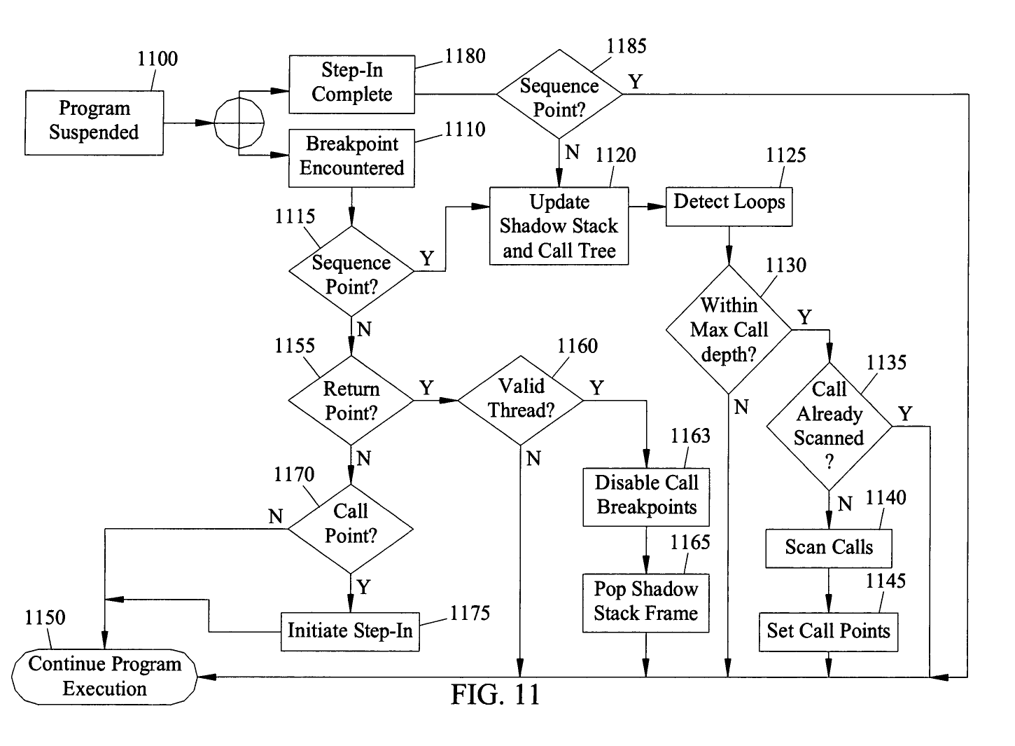

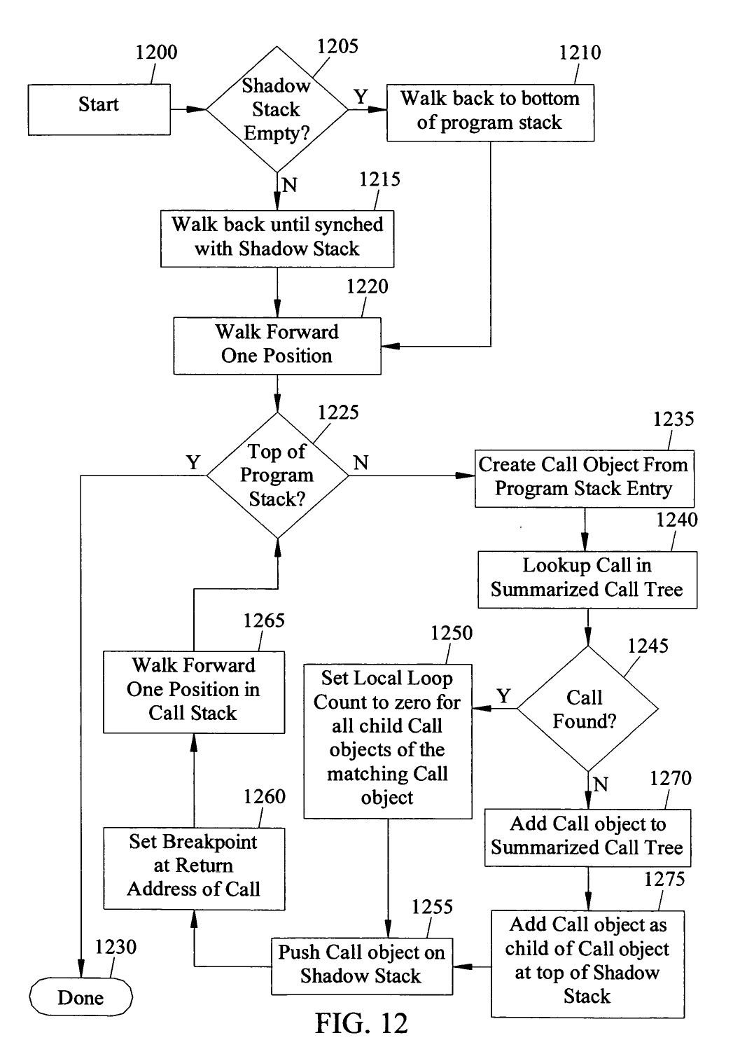

FIG. 11 illustrates exemplary overall steps that may be performed by a sequence analysis engine in using debugger services to control program execution and build the summarized call tree and shadow stack data structures according to an embodiment of the present invention. Referring to FIG. 11, in step 1100, execution of a program is suspended due to a breakpoint event. If the breakpoint event is caused by a breakpoint set by the user, control proceeds to steps 1110 and 1115 where it is determined whether the breakpoint is a sequence point. As described above, a sequence point is a function breakpoint defined by the user at the first instruction of a method. If the breakpoint is determined to be a sequence point, control proceeds to step 1120 where the shadow stack and the summarized call tree are updated. Exemplary steps for updating the shadow stack and the summarized call tree will be described below with regard to FIG. 12.

In step 1125, the sequence analysis engine detects loops. This step may be performed using the shadow stack, the summarized call tree, and the local loop counter for each call currently on the monitored program's call stack. Detecting loops also includes recording the origin of each loop using the summarized call tree, as described above. In step 1130, the sequence analysis engine determines whether it is within a maximum call depth from the nearest sequence point. If it is determined that the analysis is within the maximum call depth, then the sequence analysis engine may continue exploring interactions between function or method calls by setting call breakpoints on all statements in the current method. If the sequence analysis engine is not within the maximum call depth, then execution of the program should resume. Maximum call depth may be programmable by the user depending on the desired depth of analysis desired by the user. Accordingly, if it is determined whether the maximum call depth has not been exceeded, control proceeds to step 1135 where the SAE begins the process of scanning the current method for call instructions by determining whether the current call in the current method has already been scanned. If the call has not been scanned, control proceeds to step 1140 where the method is scanned for calls. In step 1145, call breakpoints are set at each detected call statement so that program execution can be halted at each call statement and relationships between function calls can be determined. Breakpoints that are automatically set by the SAE at calls within a method being analyzed are referred to herein as call points. Control then proceeds to step 1150 where program execution is resumed.

Returning to step 1115, if a breakpoint is determined not to be a sequence point, control proceeds to step 1155 where it is determined whether the breakpoint corresponds to a return point. A return point is a breakpoint set at the instruction in a function that causes the function to return. If the instruction is determined to be a return point, control proceeds to step 1160 where it is determined whether the current thread of execution is a valid thread. If the current thread of execution is a valid thread, control proceeds to step 1163 where call points or call breakpoints in the current method are disabled. In step 1165 the shadow stack frame containing the current function that is returning is removed or popped from the shadow stack. Execution of the program then resumes at step 1150.

Returning to step 1155, if the current breakpoint is determined not to be a return point, control proceeds to step 1170 where it is determined whether the current breakpoint is a call point. As described above, a call point may correspond to a function that is desired to be stepped into in order to analyze relationships between calls. Call points may be automatically set by the SAE, as indicated by step 1145. If the breakpoint is determined to be a call point, control proceeds to step 1175 where the debugger step in services used to step into the function corresponding to the call point. Once the step-in has been performed, control returns to step 1150 where program execution is resumed.

Returning to step 1100, if program execution is halted due to a breakpoint event and the breakpoint event is a step in complete event, control proceeds to step 1180 where analysis of the stepped-into function begins. In the stepped-into function, the SAE first determines in step 1185 whether a sequence point is present in the function. If a sequence point is present, control proceeds to step 1150 where execution of the program is resumed. The program will be suspended when the sequence point breakpoint is encountered. If the stepped-into function does not include a sequence point, control proceeds to step 1120 where the shadow stack and the summarized call tree are updated. Steps 1125-1145 may be repeated to detect loops, and automatically set call points within the stepped-into function, provided that the maximum call depth has not been exceeded. Thus, using these steps, interactions between multiple layers of function calls may be automatically analyzed. Once analysis of the stepped-into function is complete, execution of the program is resumed.

Maintaining a shadow stack and a summarized call tree is an important step in summarizing the execution flow of a computer program. Therefore, it is appropriate to further discuss the process of building and maintaining the shadow stack and the summarized call tree. As illustrated by step 1120 in FIG. 11, the SAE updates the shadow stack and the summarized call tree while processing sequence points and while processing the step-in complete debug event. The first step in the process is to walk back (from top to bottom) on the program's call stack until the current stack frame matches the top frame of the shadow stack. A match is found when both stack frames refer to the same method. After this step, the shadow stack and the program's call stack are considered to be synchronized. In the next step, the SAE walks forward (toward the top) on the call stack and creates a call object from the program's current stack frame. This call object is used to perform a lookup operation in the summarized call tree. If the summarized call tree currently contains a matching call, the SAE resets the local loop count for all child call objects of the matching call. Resetting the local loop count for child calls is in important step because it allows the SAE to determine the origin of execution loops. If the summarized call tree does not currently contain a call object matching the call associated with the program's stack frame, then the method call has never been made in the current context and the call object must be added to the summarized shadow stack. Adding the call to the shadow stack involves adding it as a child of the call object at the top of the shadow stack. If the call object was found in the summarized call tree, the matching call object is resurrected from the summarized call tree and pushed onto the top of the shadow stack. If the call object was not found in the summarized call tree, newly created Call object is pushed onto the top of the shadow stack. The whole process, described above, repeats until the SAE has processed the top stack frame in the monitored program's call stack.

FIG. 12 is a flow chart illustrating an exemplary process for updating the shadow stack and the summarized call tree. Referring to FIG. 12, the process of updating the shadow stack and the summarized call tree begins in step 1200. In step 1205, it is determined whether the shadow stack is empty. If the shadow stack is empty, control proceeds to step 1210 where SAE walks to the bottom of the program's call stack. Since the bottom of the program's call stack corresponds to the current instruction and the shadow stack is empty, the shadow stack and the program stack are synched. In step 1205, if the shadow stack is not empty, control proceeds to step 1215, where the SAE walks back from the bottom of the program stack until the SAE arrives at the instruction corresponding to the current state of the shadow stack.

Once the program stack and the shadow stack are synched, control proceeds to step 1220 where the SAE walks forward one position in the program stack. In step 1225, the SAE determines whether the current position is the top of the program stack. If the current position is the top of the program stack, there is no need to update the shadow stack because the program stack does not include any further instructions that are not already in the shadow stack. Accordingly, control proceeds to step 1230 where the process of updating the shadow stack completes.

If, however, the current position is not the top of the shadow stack, there are instructions in the call stack that have not been placed in the shadow stack. Accordingly, control proceeds to step 1235 where a call object is created based on the current program stack entry. The call object is used to perform a lookup in the summarized call tree. In step 1245, the SAE determines whether a match for the current call is found in the summarized call tree. If a match is found, control proceeds to step 1250 where the SAE sets the local loop count to zero for all child call objects matching the call object. In step 1255, the call object is pushed on to the shadow stack. In step 1260, the SAE sets a breakpoint at the return address of the function call. In step 1265, the SAE walks forward one position in the call stack. Control then returns to step 1225.

Returning to step 1245, if the call is not found in the summarized call tree, control proceed to step 1270 where the call object is added to the summarized call tree. Instep 1275, the call object is added as a child of the call object at the top of the shadow stack. Control then returns to step 1255 where the call object is pushed on to the shadow stack, step 1260 where a breakpoint is set at the return of the current call, and step 1265 where the next instruction in the call stack is accessed.

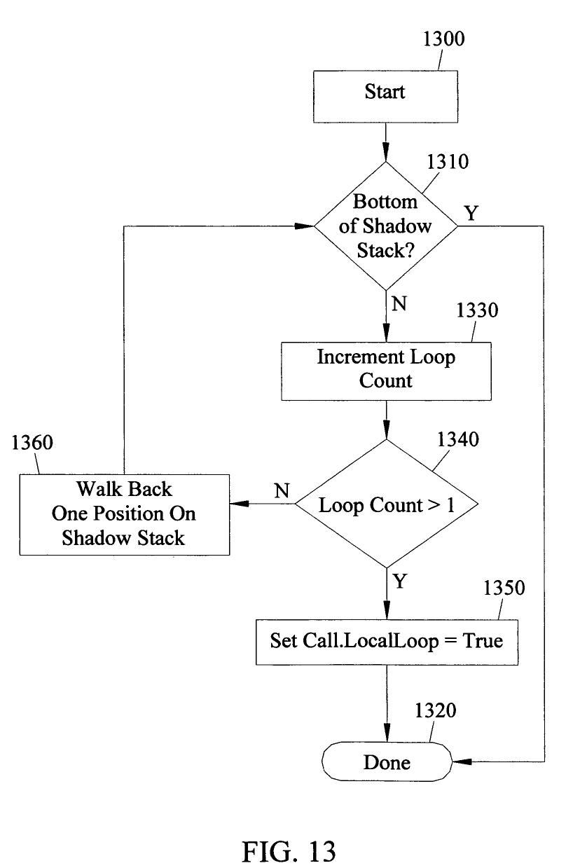

Detecting the origin of execution loops is crucial to accurately summarize the behavior of a computer program. As illustrated by step 1125 in FIG. 11, the SAE may perform loop detection while processing sequence point breakpoints and while processing step-in-complete debugger events. FIG. 13 illustrates exemplary steps for detecting the origin of execution loops in the monitored program according to an embodiment of the present invention. The approach involves iterating from the top of the shadow stack toward the bottom while incrementing the LocalLoopCount for each call and then checking to see if the LocalLoopCount is greater than one. If the LocalLoopCount is greater than one, then the SAE sets the LocalLoopDetected attribute of the Call to true and the loop detection process is complete. The key to making the loop detection function work is combining the use of the shadow stack with the summarized call tree in order to detect whether or not a child call was called by its parent Call (in the summarized call tree) more than once while the parent call was active on the shadow stack. To accomplish this, the LocalLoopCount for the call is reset to zero whenever the parent call is resurrected from the summarized call tree and placed on the shadow stack (see FIG. 12, block 1250). The logic is as follows: if the parent call has been resurrected from the call tree then all child call objects of the parent call have never been called before in the current context. Therefore, it is accurate to set the LocalLoopCount to zero to indicate that the call has not been executed yet. The SAE preferably does not reset the Call object's LocalLoopDetected flag. Once this flag has been set to true, it preferably remains true. This allows the SAE to determine if the call has ever been called in the context of an execution loop.

The present invention also utilizes breakpoints to establish two additional types of breakpoint locations. These breakpoint locations as return points and call points, as described above with respect to FIG. 11. Return Points are established at the return address of a method call and are used to synchronize the shadow stack with the call stack of the program being monitored. When the SAE encounters a return point, a shadow stack frame is popped from the top of the shadow stack. This step synchronizes the program's call stack with the shadow stack that is maintained by the SAE.

As described above with respect to FIG. 11, call points are established at the location of a call instruction within a given method. The SAE utilizes call points combined with the debugger step-in function to enable automatic discovery of interactions the current object has with other objects or methods. When a sequence point is encountered, the current method is scanned for call instructions. A call point is established by setting a breakpoint at the location of each call statement found during the scan. When the SAE continues execution of the monitored program, a breakpoint event will occur when the program executes an instruction located at one of the call points. If the SAE detects that a breakpoint has occurred at a call point, the SAE initiates the debugger Step-in service to step into the function identified by the call instruction. The SAE then allows the monitored program to continue. A Step-Complete event will occur once the program has successfully branched to the location of the function. When the SAE has determined that the current event is Step-Complete, it will build the shadow stack and perform the loop detection as during the processing of a sequence point, described earlier.

One of the most important aspects of summarizing the operational behavior of a computer program is detecting when a function is called from within an execution loop, and detecting the node in the summarized call tree corresponding to the sequence of functions in which the execution loop occurred. This sequence of functions is referred to herein as the origin of the execution loop. FIG. 13 illustrates an exemplary process for detecting the origin of an execution loop according to an embodiment of the present invention. Referring to FIG. 13, in step 1300, the process of detecting the origin of an execution loop call begins. In step 1310, the SAE determines whether the current instruction is located at the bottom of the shadow stack. If the current instruction is at the bottom of the shadow stack, it is either the entry point of the analysis or its origin or originating function has already been recorded. Accordingly, control proceeds to step 1320 where the process of determining the origin of a loop ends.

Returning to step 1310, if the current instruction is not at the bottom of the shadow stack, in step 1330, the loop counter in the call object associated with the function is incremented. In step 1340, it is determined whether the loop counter associated with the current call is greater than one. If the loop counter is greater than one, the SAE sets the boolean variable in the call object call.local loop to true, indicating that the current call is being called from within an execution loop. In step 1340, if the loop counter is not greater than 1, control proceeds to step 1360 where the next stack frame in the shadow stack is analyzed.

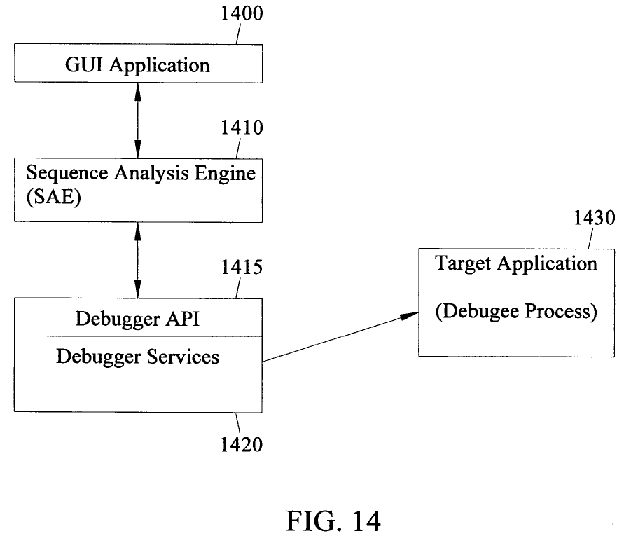

In one implementation, the present invention includes a system that can summarize the execution flow of a computer program. FIG. 14 is a block diagram illustrating an exemplary architecture for summarizing operational behavior of a computer program according to an embodiment of the present invention. As illustrated in FIG. 14 one exemplary a combination of a GUI application 1400, SAE 1410, and debugger services 1420 to monitor the execution flow of a target application 1430. GUI application 1400 may be any suitable type of GUI application for controlling the operation of an underlying program, such as sequence analysis engine 1410. In one example, GUI application 1400 may be a windows based GUI application. Sequence analysis engine 1410 may also be a software application configured to control target application 1430 using the debugger API 1415 to access debugger 1420. Sequence analysis engine 1410 may implement the steps described above with regard to FIGS. 8, 11, 12, and 13 to analyze and summarize operational behavior of target application 1430. Target application 1430 may be any suitable target application desired to be analyzed. Target application 1430 may be written using an object-oriented language or a procedure-oriented language.

In operation, GUI application 1400 may allow a user to configure inputs for the SAE 710, control the operation of SAE 1410 (start, stop, pause), and to view and manipulate the outputs from SAE 1430. SAE 1410 interacts with debugger 1420 to control target application 1430 and examine/record its execution. The services of debugger 1420 are accessed by SAE 1410 by utilizing debugger API 1415. It should be noted that debugger APIs are often provided by debugger frameworks in order to offer customized debugging capabilities.

SAE 1410 may utilize debugger services 1420 in order to examine and record the execution flow of a computer program. While most debugger applications are used by computer programmers to isolate and fix bugs in computer programs, it is possible to automate the use of debugger services to control, examine, and record the execution of a computer program. It is this automated use that allows SAE 1410 to step into methods, scan for call statements, and set new breakpoints at the call statements as described above with respect to FIG. 11.

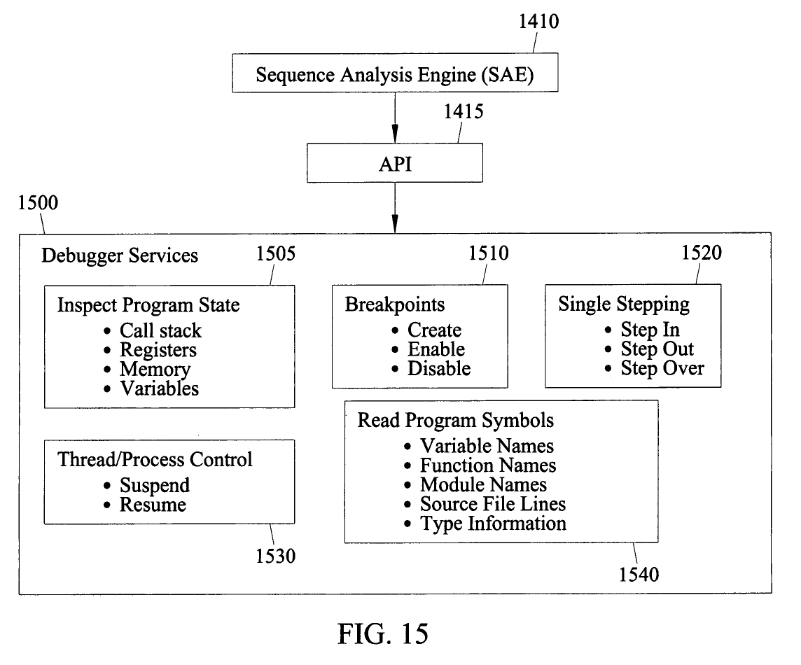

In performing automated analysis of target application 1430, SAE 1410 may utilize services that are commonly offered by debuggers. FIG. 15 illustrates exemplary debugger services that may be accessed by SAE 1410. SAE 710 uses the debugger API 1415 to access debugger services 1500, including services 1505 for inspecting the state of a program, services 1510 for setting and clearing breakpoints, services 1520 for single stepping into/over computer instructions, services 1530 for controlling the execution of threads and processes, and services 1540 for accessing debug symbols.

SAE 1410 may utilize debugger services to inspect the program state, including the program call stack, local and global variables, and the state of computer registers. Of particular interest is the data that is stored on the call stack. The call stack is composed of stack frames. Each stack frame relates to a method that is currently being executed by the program. Information in the stack frame includes local variables and the return address of the next statement to execute once the method being called has returned. SAE 1410 may walk the call stack and examine the contents of each stack frame. SAE 1410 stores the return address stored in the stack frame when it detects a new call. This return address can be used to identify the memory address of the call statement.

Another debugger service that is utilized extensively by SAE 1410 is the breakpoint service 1510. SAE 1410 utilizes the breakpoint service to create, enable, and disable breakpoints. A breakpoint is a special computer instruction that halts the current program and gives control to debugger 1420. In most cases debugger 1420 actually replaces a specified computer instruction with a special instruction that causes a breakpoint exception to occur. When a breakpoint exception occurs, debugger 1420 catches the exception and suspends execution of the application. When a debug breakpoint is encountered most debuggers allow the user to visually inspect the state of the suspended program, including the registers, memory, local/global variables, and the call stack. As described above, SAE 1410 uses debugger breakpoints to gain control of a program at predetermined locations referred to herein as sequence points. A sequence point is established by setting a function breakpoint on the first instruction of a method. SAE 1410 utilizes sequence points to focus analysis on interactions between select classes and/or methods. SAE 1410 is notified by the debugger service whenever a debug breakpoint is encountered. After analyzing the current call stack and recording the execution flow, SAE 1410 uses the debugger services to resume execution of the suspended program.

SAE 1410 may utilize single stepping services to explore interactions for select classes/methods. Debugger 1420 provides services that allow SAE 1410 to control the execution of a single instruction or of a range of instructions. The Step-In service allows SAE 1410 to step into a function that is referenced by a call instruction. As described above, SAE 1410 utilizes the Step-In service to analyze a function that is referenced by a call point, see FIG. 11, step 1170.

SAE 1410 utilize the Suspend service to temporarily pause a program's thread in order to inspect program state and set required breakpoints. SAE 1410 may utilize the Resume service to resume a suspended thread when analysis is complete.

In addition to using debugger services to control program execution, SAE 1410 may also utilizes debugger services for reading program symbols. These symbols allow SAE 1410 to identify the memory locations of functions specified by the user and associate low level machine/intermediate instructions to higher level source code statements. This mapping allows SAE 1410 to annotate the sequence diagrams with fragments of source code. The ability to display source code in generated sequence diagrams greatly enhances the diagram's ability to summarize the execution flow of a computer program.

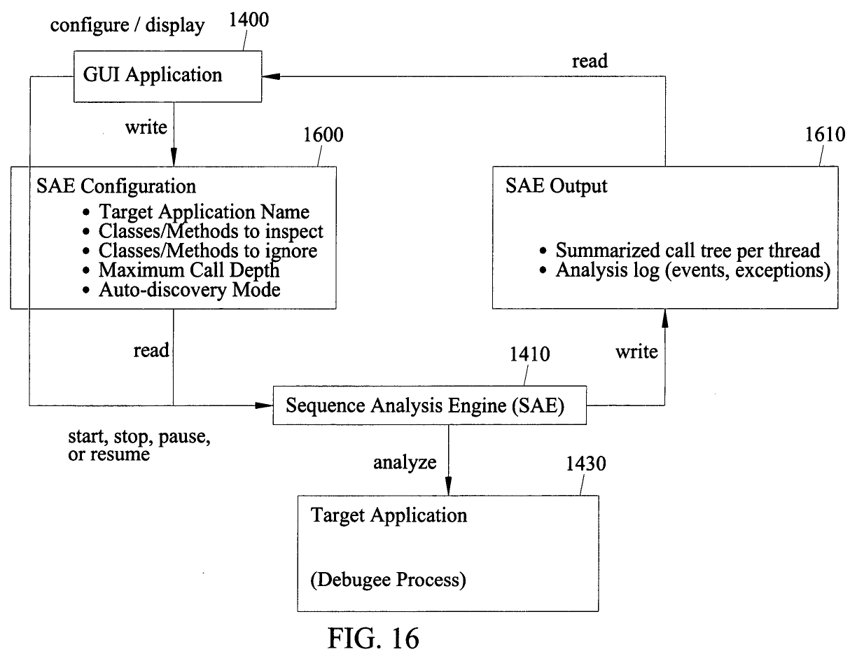

FIG. 16 is a block diagram illustrating operational relationships between GUI application 1400, SAE 1410, and target application 1430. As illustrated in FIG. 16, GUI application 1400 may allow the user to specify SAE configuration inputs 1600, such as the target application being analyzed, the classes/methods to include in the analysis, classes/methods to ignore, the maximum call depth for monitoring functions calls, and a flag which indicates whether or not auto-discovery mode is enabled. GUI application 1400 may also allow the user to control the analysis session, including the ability to start, stop, pause, and resume analysis. To start analysis of the target application, the GUI Application sends a command to SAE 1410 to inform it that it is time to begin analysis. SAE 1410 reads the inputs and begins analysis of the target application. When analysis is complete, or when analysis is stopped by the user, SAE 1410 will output the results of the analysis, including a summarized call tree for each analyzed thread of execution. SAE output 1610 is subsequently loaded by the GUI application 1400 and diagrams depicting the flow of execution are generated and displayed in graphical form.

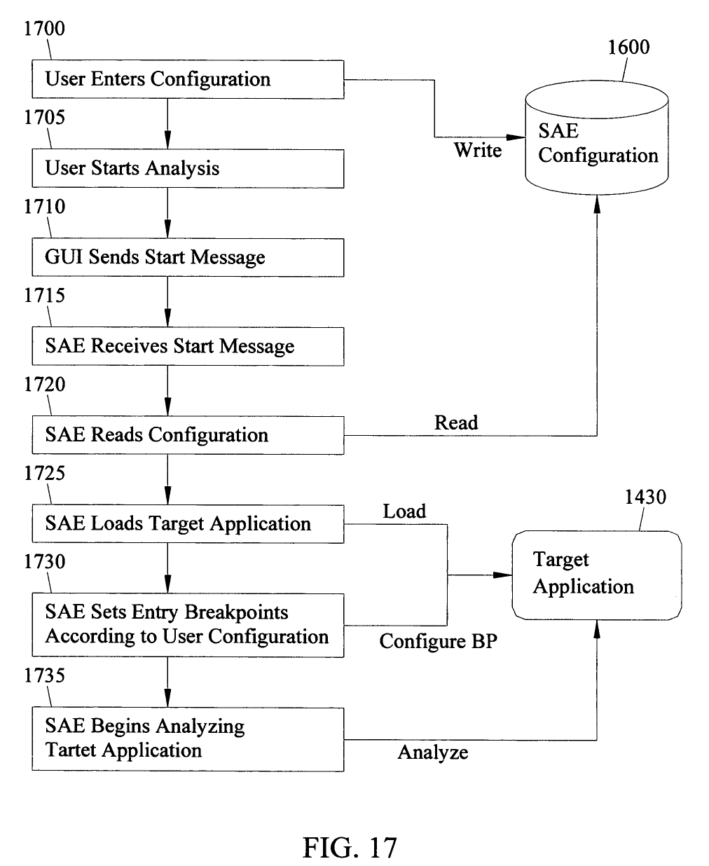

FIG. 17 is a flow chart illustrating exemplary steps that may be performed by a user in initiating analysis of a target application according to an embodiment of the present invention. Referring to FIG. 17, in step 1700, a user enters configuration information, such as the target application being monitored, classes or methods to inspect, classes or methods to ignore, maximum call depth, and whether auto discovery mode will be enabled. In step 1705, the user starts the analysis by selecting a start menu button. In step 1710, in response to the start menu button from the user, GUI application 1400 sends a start message to SAE 1410. In step 1715, SAE 1410 receives the start message. In step 1720, SAE 1410 reads configuration information 1600 entered by the user in step 1700. In step 1725, SAE 1410 loads the target application.

In order to analyze the target application, in step 1730, SAE 1410 sets entry breakpoints according to the user configuration. In step 1735, SAE 1410 analyzes the target application using the steps described above with regard to FIGS. 8, 11, 12, and 13. The present invention is not limited to starting analysis of a target application in response to a command received from a user. In an alternate implementation, SAE 1410 may start analysis of the target application using a user-defined trigger event, such as when a variable reaches a value specified by the user. When the trigger event occurs, the SAE may enable all breakpoints specified by the user.

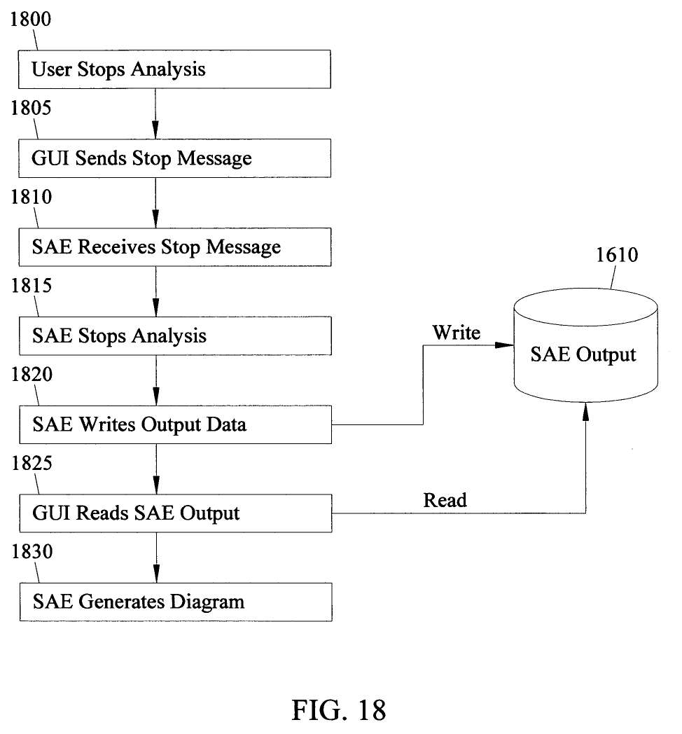

FIG. 18 illustrates exemplary steps that may be performed by a user in stopping analysis of a target application. Referring to FIG. 18, in step 1800, a user stops the analysis, for example, by pressing a stop menu button provided by GUI 1400. In step 1805, GUI application 1400 sends a stop message to SAE 1410. In step 1810, SAE 1410 receives the stop message from GUI 1400. In step 1815, SAE 1410 stops the analysis of the target application. In step 1820, SAE 1410 writes output data to SAE output 1610. Exemplary output may include method calls and a context for each method call, as described above. In step 1825, GUI 1400 reads SAE output 1610. In step 1830, SAE 1410 generates a diagram that summarizes the execution of the program, such as a sequence diagram.

Thus, the present invention includes methods, systems, and computer program products for summarizing the operational behavior of a computer program. The method may include setting execution breakpoints at functions of interest in computer program code. The computer program code is then executed to analyze the operational behavior of the computer program. During execution of the computer program, conditional execution and looping of each function of interest are tracked. A summary of the conditional execution and looping is produced and displayed to the user.

It will be understood that various details of the invention may be changed without departing from the scope of the invention. Furthermore, the foregoing description is for the purpose of illustration only, and not for the purpose of limitation—the invention being defined by the claims.

1. A method for summarizing operational behavior of a computer program, the method comprising:
(a) executing a computer program in a mode that allows control over execution of the computer program;
(b) pausing execution of program at predetermined locations corresponding to instructions in the computer program; and
(c) for each location:
(i) recording contents of a call stack containing function calls made by the program that have not yet returned; and
(ii) for each function call in the call stack, recording conditions under which the function was called.

2. The method of claim 1 wherein executing the computer program in a mode that allows control over execution of the computer program includes executing the computer program under control of debugger services.

3. The method of claim 1 wherein executing the computer program in a mode that allows control over execution of the computer program includes executing the computer program under control of profiler services.

4. The method of claim 1 wherein executing the computer program in a mode that allows control over execution of the computer program includes inserting statements in the computer program to pause execution of the computer program and executing the computer program under control of the operating system.

5. The method of claim 1 wherein pausing execution of the program at predetermined locations corresponding to instructions in the computer program includes pausing the computer program at breakpoints set by a user at function calls or method calls of interest in the computer program.

6. The method of claim 1 wherein pausing execution of the program at predetermined locations corresponding to instructions in the computer program includes using debugger services to automatically set breakpoints at call statements within a function in the computer program and pausing execution of the computer program at the automatically-set breakpoints.

7. The method of claim 1 wherein recording contents of a call stack includes creating a call stack object for each function call in the call stack, creating a shadow stack, and storing the call stack objects in the shadow stack.

8. The method of claim 7 wherein recording conditions under which each function was called includes creating a summarized call tree, and storing indicators of each call object in the summarized call tree.

9. The method of claim 8 comprising identifying whether each call in the shadow stack is called in an execution loop and the scope of the execution loop by maintaining a local loop counter for each call object and incrementing the local loop counter for each occurrence of each call object in the shadow stack.

10. The method of claim 9 comprising applying post processing to each call object in the summarized call tree to identify conditionally executed blocks of code and execution loops.

11. The method of claim 10 comprising summarizing the operational behavior of the program in a format that includes notation for identifying conditionally executed blocks of code and execution loops.

12. The method of claim 11 wherein the format includes a sequence diagram.

13. The method of claim 12 comprising using debug symbols to supplement the sequence diagram with loop and conditional notation containing fragments of source code from the computer program that corresponds to intermediate instructions that indicate a loop or conditional statement.

14. A system for summarizing the operational behavior of a computer program, the system comprising:
(a) a first data structure for storing information corresponding to calls currently on a call stack of a target computer program being executed;
(b) a second data structure for storing a history of function calls made by the computer program and contexts in which the function calls were made; and
(c) a sequence analysis engine for controlling execution of the computer program, for pausing the execution at predetermined locations in the computer program, and, at each location, for storing contents of the computer programs call stack in the first data structure and updating the second data structure based on the contents of the computer program's call stack.

15. The system of claim 14 wherein the first data structure comprises a shadow stack for storing call object indicators for calls currently on the program's call stack.

16. The system of claim 15 wherein each call object referred in the shadow stack stores caller and callee information for the function call and a local loop counter for each function call.

17. The system of claim 14 wherein the second data structure comprises a call tree indicating parent-child relationships between calls currently in the call stack.

18. The system of claim 14 wherein the sequence analysis engine is adapted to use debugger services to control execution of the program.

19. The system of claim 14 wherein the sequence analysis engine is adapted to use profiler services to control execution of the computer program.

20. The system of claim 14 wherein the sequence analysis engine is adapted to use instructions embedded in source code of the computer program to control execution of the computer program to control execution of the computer program.

21. The system of claim 14 wherein the sequence analysis engine is adapted to pause execution of the computer program at breakpoints set by a user and update contents of the first and second data structures for each breakpoint.

22. The system of claim 14 wherein the sequence analysis engine is adapted to automatically set breakpoints at call statements in a function being analyzed and to use debugger step-in services to determine relationships between the call statements and the function being analyzed.

23. The system of claim 14 wherein the sequence analysis engine is adapted to analyze intermediate language code to detect blocks of code that are conditionally executed.

24. The system of claim 14 wherein the sequence analysis engine is adapted to analyze intermediate language code in the computer program to detect groups of calls corresponding to the same execution loop.

25. The system of claim 14 wherein the sequence analysis engine is adapted to analyze machine language code to detect blocks of code that are conditionally executed.

26. The system of claim 14 wherein the sequence analysis engine is adapted to analyze machine language code in the computer program to detect groups of calls corresponding to the same execution loop.

27. The system of claim 26 wherein the sequence analysis engine is adapted to generate a behavioral diagram indicating the conditionally executed blocks of code and loops.

28. The system of claim 27 wherein the sequence analysis engine is adapted to use debug symbols to supplement the behavioral diagram with loop and conditional notation containing fragments of source code corresponding to guard conditions for the loops or conditional notation.

29. The system of claim 28 wherein the behavioral diagram comprises a sequence diagram.

30. A computer program product comprising computer-executable instructions embodied in a computer-readable medium for performing steps comprising:
(a) executing a computer program in a mode that allows control over execution of the computer program;
(b) pausing execution of program at predetermined locations corresponding to instructions in the computer program; and
(c) for each location:
(i) recording contents of a call stack containing function calls made by the program that have not yet returned; and
(ii) for each function call in the call stack, recording conditions under which the function was called.

31. The computer program product of claim 30 wherein executing the computer program in a mode that allows control over execution of the computer program includes executing the computer program under control of debugger services.

32. The computer program product of claim 30 wherein executing the computer program in a mode that allows control over execution of the computer program includes executing the computer program under control of profiler services.

33. The computer program product of claim 30 wherein executing the computer program in a mode that control over execution of the computer program includes inserting statements in the computer program to pause execution of the computer program and executing the computer program under control of the operating system.

34. The computer program product of claim 30 wherein pausing execution of the program at predetermined locations corresponding to instructions in the computer program includes pausing the computer program at breakpoints set by a user at function calls or method calls of interest in the computer program.

35. The computer program product of claim 30 wherein pausing execution of the program at predetermined locations corresponding to instructions in the computer program includes using debugger services to automatically set breakpoints at call statements within a function in the computer program and pausing execution of the computer program at the automatically-set breakpoints.

36. The computer program product of claim 30 wherein recording contents of a call stack includes creating a call stack object for each function call in the call stack, creating a shadow stack, and storing the call stack objects in the shadow stack.

37. The computer program product of claim 36 wherein recording conditions under which each function was called includes creating a summarized call tree, and storing indicators of each call object in the summarized call tree.

38. The computer program product of claim 37 comprising identifying whether each call in the shadow stack is called in an execution loop and the scope of the execution loop by maintaining a local loop counter for each call object and incrementing the local loop counter for each occurrence of each call object in the shadow stack.

39. The computer program product of claim 38 comprising applying post processing to each call object in the summarized call tree to identify conditionally executed blocks of code and execution loops.

40. The computer program product of claim 39 comprising summarizing the operational behavior of the program in a format that includes notation for identifying conditionally executed blocks of code and execution loops.

41. The computer program product of claim 38 wherein the format includes a sequence diagram.

42. The computer program product of claim 40 comprising using debug symbols to supplement the sequence diagram with loop and conditional notation containing fragments of source code from the computer program that corresponds to intermediate instructions that indicate a loop or conditional statement.
